(19) United States
(12) Patent Application Publication
(10) Pub. No.: US 2012/0270195 A1
(43) Pub. Date: Oct. 25, 2012

(54) Scalpel Brush

(76) Inventor: David M. Velarde, Knoxville, TN (US)

(21) Appl. No.: 13/221,178

(22) Filed: Aug. 30, 2011

Related U.S. Application Data
(60) Provisional application No. 61/477,664, filed on Apr. 21, 2011.

(51) Int. Cl. G09B 23/28

(52) U.S. Cl. 434/262

(57) ABSTRACT

A scalpel brush painting device, comprising a retaining ferrule having two open ends, a plurality of bristles protruding from one of the open ends of the retaining ferrule, and a handle attached to or, in some embodiments, releasably attached to the other of the open ends of the retaining ferrule. The scalpel brush painting device can be utilized to train the fine muscles of a user's hand in similar manner as when making incisions utilizing a scalpel, as when painting on a painting medium, and to train the user's hand for the various grip positions utilized when holding a scalpel.

### CROSS-REFERENCE TO RELATED APPLICATIONS

This application claims the benefit of U.S. Provisional Application 61/477,644, filed Apr. 21, 2011.

### STATEMENT REGARDING FEDERALLY-SPONSORED RESEARCH OR DEVELOPMENT

Not Applicable.

### BACKGROUND OF THE INVENTION

1. Field of Invention

The present invention relates generally to paint brushes, and, more particularly, to a paint brush with a scalpel handle.

2. Description of the Related Art

Developing skilled medical practitioners is paramount to the maintenance and progress of various health care industries, including human health care, as well as veterinary and zoological health care. Indeed, adequate training is critical, especially for individuals who will engage in surgical procedures.

The arts often play a critical role in the development of medical practitioners. Researchers have concluded that some familiarity with the arts enhance student well-being, improve clinical skills, and promote humanism. Art, especially visual art such as painting, sculpting and the like, enhances the overall learning experience of many students. For example, studying the anatomically-artistic works of Andreas Vesalius (known as the founder of modern human anatomy) may motivate students to take additional anatomy courses. Similarly, art may also manifest itself as a teaching tool, either in the classroom or as a self-learning module, to facilitate understanding the basic concepts in an integrated medical curriculum that includes study of the visual arts.

Surgeons must be trained on many levels, including the development of the fine muscles in the hand associated with scalpel manipulation and the incision process. These muscles must be taught to control the hand, thus the scalpel, in a very precise manner. Precision control is essential because of the severe consequences which may result from even a miniscule deviation of the scalpel blade while making an incision.

Training individuals to develop the required fine motor skills for surgery has traditionally had limitations. For example, when learning how to make an incision with a scalpel, pupils must often practice on cadaveric specimens. Concerns about the specimen's tissue quality, temperature, and preparation usually mandate procurement of the cadaveric specimens from a cadaveric lab service. Such specimens must be purchased in advance in order to assure arrival for the desired training exercise. This can be both costly and inconvenience, particularly when the primary objective of the exercise is merely to practice making incisions and develop the fine motor skills associated with cutting utilizing a scalpel apparatus.

While some surgical training programs encourage pupils to develop hand-eye coordination through the play and use of video games, such development does not correlate directly to the particular hand muscles involved when holding and using a scalpel.

Generally, scalpels are comprised of a blade and a handle. Handles are typically elongated and flat, although some have a cylindrical portion near the blade that flattens out at the other end. Others are entirely cylindrical. Scalpel blades come in a variety of shapes and sizes, depending on the intended use of the blade. Additionally, many scalpels have removable blades, which are equipped with particular fitment sizes to accommodate numerous compatible blades for one scalpel handle.

Scalpel handles are gripped in a number of different ways, and pupils should become adept with each grip type. For example, one grip, the palmar grip, is achieved by the individual's second, third, and fourth fingers securing the side of the handle against the thumb, with the index finger placed along the top of the blade. Conversely, the palm grip requires the individual to hold the scalpel under the palm, with the thumb pressing down on top of the blade, and the fingers curled under and around the handle. Another grip is the pencil grip, which is achieved by holding the scalpel with the thumb and index finger, and positioning the handle over the top of the space between the thumb and index finger. Yet another grip, the fingertip grip, has the individual holding the scalpel between the thumb and the index, second and third fingers, with the palm of the hand over the scalpel handle.

Known prior art discloses numerous variations of both scalpels and paint brushes. The prior art, however, does not teach a paint brush equipped with the handle of a scalpel, nor does the prior art disclose a paint brush attachment for a scalpel handle. The combination of a scalpel handle with a paint brush creates a new and efficient way for individuals to train the fine muscles of the hand specifically associated with correct scalpel manipulation and precise incising utilizing a scalpel. In addition, a Scalpel Brush as disclosed can serve as a bridge between two related yet distinct areas of study: art and medicine.

### BRIEF SUMMARY OF THE INVENTION

The present invention, a Scalpel Brush, in some of its various embodiments, comprises a painting device, the device including a retaining ferrule, a plurality of bristles held together by the retaining ferrule, and a handle. In some embodiments, the plurality of bristles has one composite end inserted into one end of the retaining ferrule and the other composite end of the plurality of bristles projecting outward from the retaining ferrule. In some embodiments, the handle has a gripping portion defined on one end of the handle and a connecting portion on another end of the handle. In some embodiments, the handle has a gripping portion defined to have a nearly flat top surface and a nearly flat bottom surface. In some embodiments, the handle has a connecting portion which extends from a gripping portion of the handle into the retaining ferrule, thereby attaching the handle to the plurality of bristles attached to the other end of the ferrule. In some embodiments, the invention further includes a releasably attachable attachment member, having defined thereon two ends, with one end inserted into the retaining ferrule and the other end releasably attached to the handle, whereby various types of pluralities of bristles, each plurality inserted into its own retaining ferrule, may be utilized and interchangeably releasably attached to the handle. In some embodiments, the handle is defined to have a releasably attachable end, whereby the retaining ferrule may be releasably attached directly to the handle, and thus various pluralities of bristles may be interchangeably releasably attached to the handle. In some embodiments, the releasably attachable end of the handle is defined to include a series of graduated surfaces of decreasing perimeter size for receiving ferrules having an internal surface configured to correspond with the graduated surfaces, to facilitate attachment of the retaining ferrule to the handle. The graduated surfaces may be either basically round or basically rectilinear, depending on the shape of the retaining ferrule to be attached to the handle. The graduated surfaces must be slightly smaller in outer dimension than the inner dimension of the attaching end of the retaining ferrule, in order to provide a secure attachment between the graduated surfaces and the retaining ferrule. Ideally, in these embodiments, the retaining ferrule should “snap” onto the graduated surfaces and remain releasably attached to the handle via tension upon the graduated surfaces until such time as the user desires to remove the retaining ferrule off the handle by manipulating the retaining ferrule and handle to pull the two apart. In some embodiments, the handle is defined to be a surgical scalpel handle, having defined thereon an attachment element such as is standard in the industry, whereby releasably attachable attachment devices may be releasably attached to the surgical scalpel handle.

### BRIEF DESCRIPTION OF THE DRAWINGS

The above-mentioned and additional features of the invention will become more clearly understood from the following detailed description of the invention read together with the drawings in which:

FIG. 1 illustrates an exploded view of one embodiment of the present invention.

FIG. 2 illustrates an angular side view of one embodiment of the present invention with the attachment member fully engaged with the attachment element.

FIGS. 3A through 3C illustrate, in succession, the attachment member engaging with the attachment element in one embodiment of the present invention.

FIG. 4 illustrates another embodiment of the present invention where the plurality of bristles is permanently attached to the scalpel handle.

FIG. 5 illustrates a partially-exploded view of one embodiment of the present invention.

FIG. 6 illustrates another embodiment of the present invention where the plurality of bristles is shown attached to the scalpel handle.

FIG. 7 illustrates a partially-exploded view of one embodiment of the present invention.

### DETAILED DESCRIPTION OF THE INVENTION

The present invention, in some of its embodiments, comprises a scalpel brush painting device, the device including a plurality of bristles held together by a retaining ferrule, and a handle. In some embodiments, the plurality of bristles has one composite end inserted into one end of the retaining ferrule and the other composite end of the plurality of bristles projecting outward from the retaining ferrule. In some embodiments, the handle has a gripping portion defined on one end of the handle and a connecting portion on another end of the handle. In some embodiments, the handle has a gripping portion defined to have a nearly flat top surface and a nearly flat bottom surface. In some embodiments, the handle has a connecting portion which extends from a gripping portion of the handle into the retaining ferrule, thereby attaching the handle to the plurality of bristles attached to the other end of the ferrule.

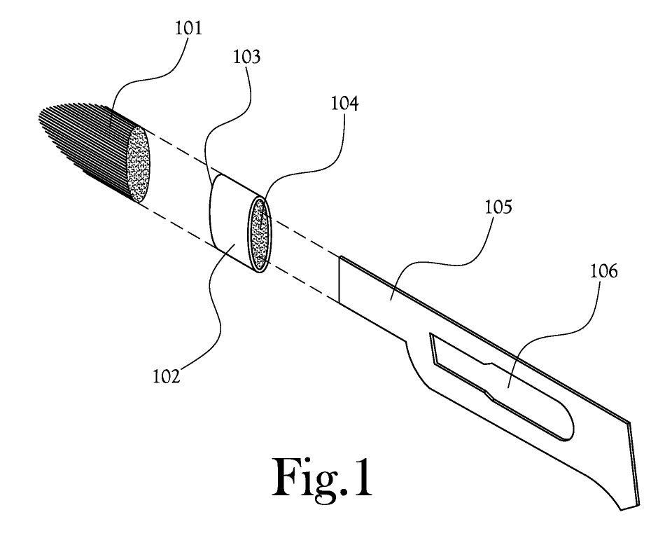

FIG. 1 illustrates an example, or one embodiment, of the present invention. A plurality of bristles 101 is bundled together by a retaining ferrule 102. Thus bundled, in some embodiments, plurality of bristles 101 approximates the size, shape and orientation of a scalpel blade, the retaining ferrule 102 being compressed such that the plurality of bristles 101 is more ovate than spheroid. Also shown in FIG. 1 is an attachment member 105 having defined within itself a slot 106, slot 106 formed so as to allow scalpel handles with standardized attachment elements to attach to opening 106. In some embodiments, an adhesive, such as epoxy, illustrated at 107, is then applied to end 104 of retaining ferrule 102 to seal the plurality of bristles 101, retaining ferrule 102, and attachment member 105.

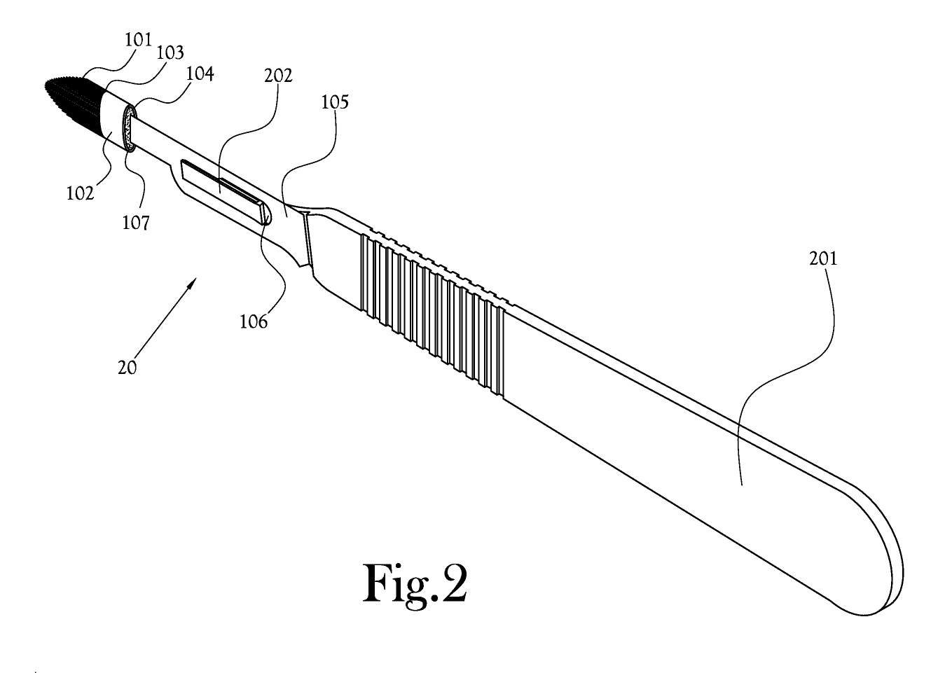

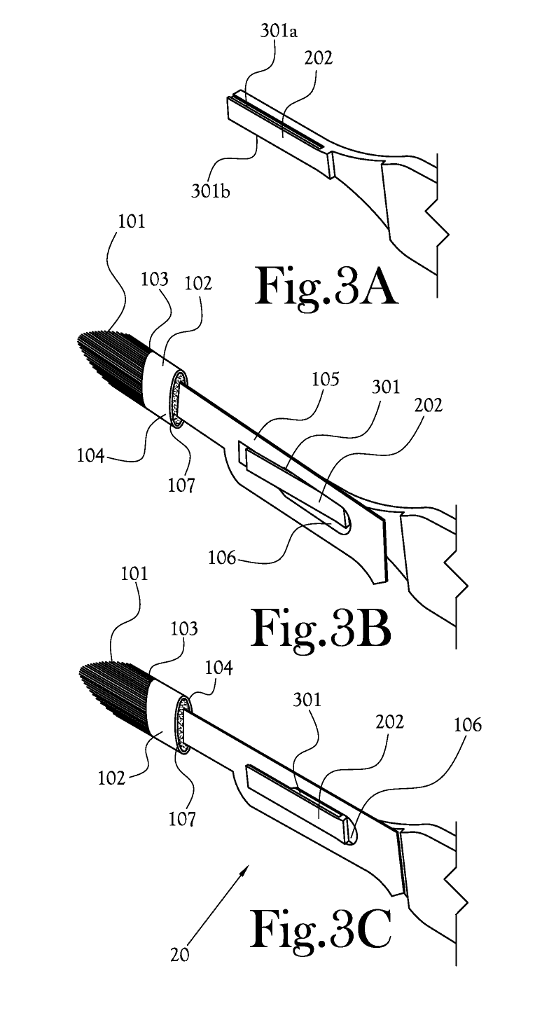

FIG. 2 illustrates plurality of bristles 101 inserted into end 103 of retaining ferrule 102, optional adhesive 107 applied to end 104 of retaining ferrule 102, and insertion of attachment member 105, defined to include slot 106, into retaining ferrule 102. Scalpel handle 201 is defined to include an attachment element 202. Scalpel handle 201 securely attaches to attachment member 105 by means of attachment element 202 inserting into slot 106 in a securely detachable manner. In some embodiments, attachment element 202 is defined to include parallel tracks 301a and 301b. In these embodiments, attachment element 202 is inserted into slot 106 of attachment member 105 such that track 301a is parallel to one side of attachment member 105 and track 301b inserts through slot 106 and sits parallel to the other side of attachment member 105. Thus inserted into slot 106, tracks 301a and 301b of attachment element 202 place opposing pressure on attachment member 105, the opposing pressure providing sufficient force so as to maintain a stationary but releasable connection 20 between attachment member 105 and scalpel handle 201 until such time as detachment is desired. Detachment of releasable connection 20 is attained by placing sufficient opposing pressure upon attachment member 105 to overcome the attachment pressure of tracks 301a and 301b, thereby opening a temporary gap between tracks 301a and 301b, and removing track 301b from slot 106, thus detaching attachment member 105 from scalpel handle 201. When fully engaged (see FIG. 2 and FIG. 3 at 20), attachment member 105 and attachment element 202 lock the plurality of bristles 101 in place and attachment member 105 and scalpel handle 201 move as one unit.

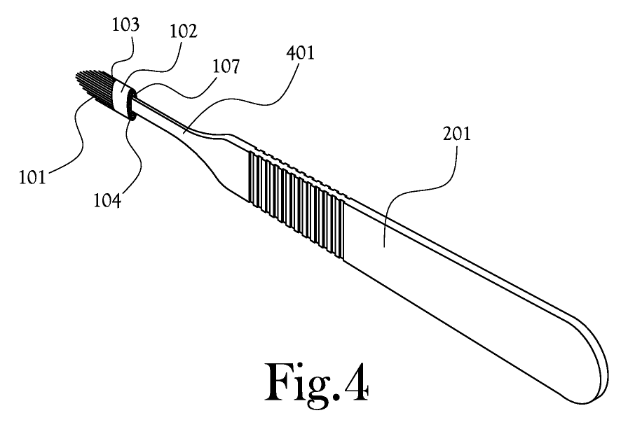

FIG. 4 illustrates another embodiment of the present invention whereby the plurality of bristles 101 and retaining ferrule 102 are fixedly attached to a scalpel handle 201. Scalpel handle 201 is defined to include connecting element 401 which extends into end 104 of retaining ferrule 102 to create an integrated Scalpel Brush which contains no releasable attachment. Optionally, an adhesive 107, such as epoxy for example, may be incorporated onto end 104 of retaining ferrule 102 to fixedly attach plurality of bristles 101 and retaining ferrule 102 onto scalpel handle 201.

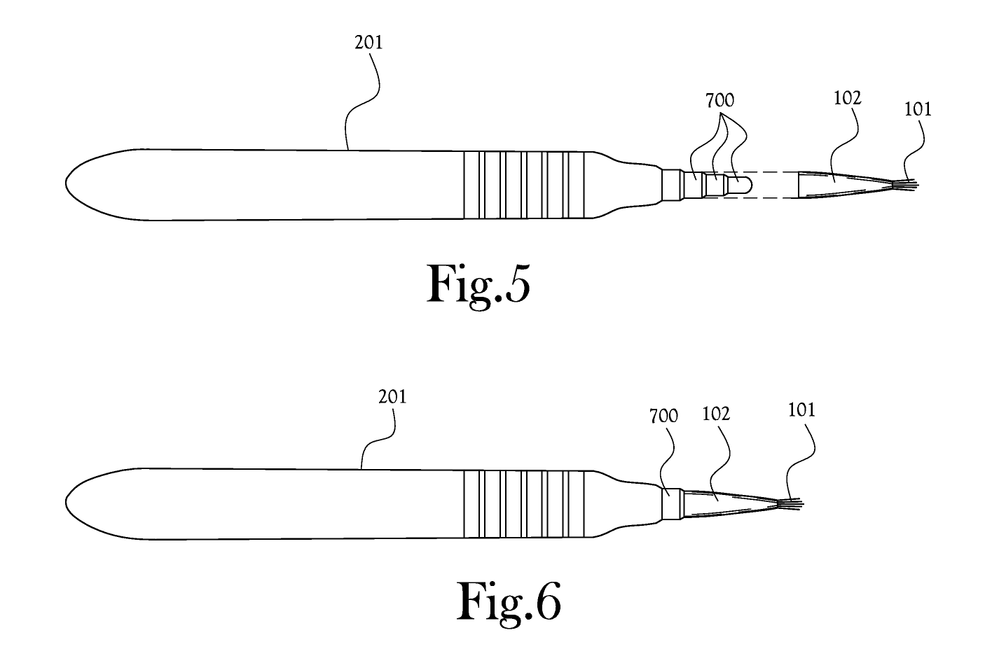

FIG. 5 illustrates another embodiment of the present invention whereby the plurality of bristles 101 and retaining ferrule 102 are releasably attachable to a scalpel handle 201. Scalpel handle 201 is defined to include a series of graduated surfaces of decreasing perimeter size 700, to facilitate attachment of retaining ferrule 102 onto handle 201. The outer dimension of the series of graduated surfaces of decreasing perimeter size 700 should be slightly smaller than the interior dimension of retaining ferrule 102 to facilitate a secure releasable attachment between the graduated surfaces of decreasing perimeter size 700 and retaining ferrule 102.

FIG. 6 shows another embodiment of the present invention whereby plurality of bristles 101 and retaining ferrule 102 are securely and releasably attached to scalpel handle 201 by means of a secure attachment upon the graduated surfaces of decreasing perimeter size 700 as defined upon handle 201.

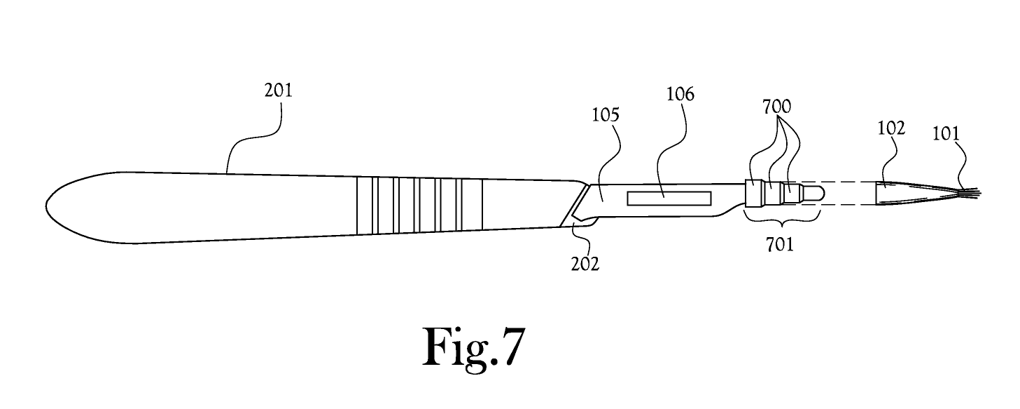

FIG. 7 illustrates another embodiment of the present invention whereby plurality of bristles 101 and retaining ferrule 102 may be releasably attached to handle 201. As shown in FIG. 7, handle 201 is defined to include attachment element 202. Attachment element 202, in some embodiments, is defined to include parallel tracks 301a and 301b (see FIG. 3A). Also shown in FIG. 7 is attachment member 105, having slot 106 defined therein, for providing a releasably attachable attachment to attachment element 202 of handle 201. In this and similar embodiments, attachment member 105 is further defined to include adaptor 701 for receiving ferrule 102, adaptor 701 having defined thereon a series of graduated surfaces of decreasing perimeter size 700. Retaining ferrule 102 may be releasably attached to adaptor 701 by forming a secure, releasable attachment between retaining ferrule 102 and the series of graduated surfaces of decreasing perimeter size 700 as defined on adaptor 701.

With any embodiment whereby the plurality of bristles 101 is secured to scalpel handle 201, the device simulates the form and function of a surgical scalpel, with the plurality of bristles 101 substituted for a scalpel blade. The user may then grip scalpel handle 201 in similar manner as he/she grips a scalpel handle during surgery, practicing all positions and various grips until functional competence has been achieved, prior to actually making incisions. Optionally, paint may be applied to the plurality of bristles 101, facilitating use of the plurality of bristles 101 to clearly delineate incision simulation, or, additionally or alternatively, utilization of the plurality of bristles 101 to engage against a painting medium.

As will be readily apparent to those skilled in the art, the present general inventive concept may be utilized in various ways. For example, persons of elementary school age or ability may utilize the present general inventive concept to learn art, anatomy, fine motor skills, and control of a surgical instrument. Similarly, persons of middle school age or ability may utilize the present general inventive concept to learn anatomy, fine motor skills, art, and control of a surgical instrument. In addition, persons pursuing study in the medical or veterinary arts may utilize the present general inventive concept to learn control of a surgical instrument, fine motor skills, anatomy, and art.

While the present general inventive concept has been illustrated by description of some embodiments, and while the illustrative embodiments have been described in detail, it is not the intention of the applicant to restrict or in any way limit the scope of the appended claims to such detail. Additional modifications will readily appear to those skilled in the art. The present general inventive concept in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A scalpel brush painting device, said device comprising:
a retaining ferrule having two open ends;
a plurality of bristles, having one collective end of said plurality of bristles inserted into one of said two open ends of said retaining ferrule to bundle said plurality of bristles together, and the opposite collective end of said plurality of bristles protruding outward away from said retaining ferrule; and
a handle having two ends, said handle having defined thereon a connecting portion on one of said two ends and a gripping portion on the opposite of said two ends, said connecting portion extending from said gripping portion of said handle into the other of said two open ends of said retaining ferrule for connection therewith to secure said plurality of bristles to said handle;
whereby said scalpel brush painting device can be utilized to train the fine muscles of a user's hand in similar manner as when making incisions utilizing a scalpel, as when painting on a painting medium, and to train the user's hand for the various grip positions utilized when holding a scalpel.

2. The scalpel brush painting device of claim 1, wherein:
said handle is further defined to be a surgical scalpel handle, said connecting portion having further defined upon said connecting portion an attachment element for use with a releasably attachable attachment member; and
said scalpel brush painting device further comprises a releasably attachable attachment member having two ends, one of said two ends of said releasably attachable attachment member being inserted into said other end of said two open ends of said retaining ferrule, and the other of said two ends of said releasably attachable attachment member being defined so as to releasably attach to a handle with an attachment element;
whereby said scalpel brush painting device can be utilized to train the fine muscles of a user's hand in similar manner as when making incisions utilizing a scalpel, as when painting on a painting medium, and to train the user's hand for the various grip positions utilized when holding a scalpel.

3. The scalpel brush painting device of claim 2, said releasably attachable attachment member having defined on said one of said two ends a series of graduated surfaces of decreasing perimeter size, said graduated surfaces of decreasing perimeter size having said perimeter size defined slightly larger than said other end of said two ends of said retaining ferrule, whereby a secure releasable attachment is created between said graduated surfaces of decreasing perimeter size of said releasably attachable attachment member and said retaining ferrule.

4. The scalpel brush painting device of claim 1, said connecting portion of said handle being defined as a series of graduated surfaces of decreasing perimeter size, said graduated surfaces of decreasing perimeter size having said perimeter size defined slightly larger than said other end of said two ends of said retaining ferrule, whereby a secure releasable attachment is created between said graduated surfaces of decreasing perimeter size of said connecting portion of said handle and said retaining ferrule.

5. A scalpel brush painting device, said device comprising:
a retaining ferrule having two open ends;
a plurality of bristles, having one collective end of said plurality inserted into one of said two open ends of said retaining ferrule to bundle said plurality of bristles together, and the opposite collective end of said plurality of bristles protruding outward away from said retaining ferrule; and
a handle having two ends, said handle having defined thereon a connecting portion on one of said two ends and a gripping portion on the opposite of said two ends, said connecting portion extending from said gripping portion of said handle into the other of said two open ends of said retaining ferrule for connection therewith to secure said plurality of bristles to said handle;
whereby said scalpel brush painting device can be utilized to train the fine muscles of a user's hand in similar manner as when making incisions utilizing a scalpel, as when painting on a painting medium, and to train the user's hand for the various grip positions utilized when holding a scalpel.

6. The scalpel brush painting device of claim 1, wherein said plurality of bristles is bundled together in such a configuration so as to approximate the size and orientation of a scalpel blade.

7. The scalpel brush painting device of claim 2, wherein said plurality of bristles is bundled together in such a configuration so as to approximate the size and orientation of a scalpel blade.

8. The scalpel brush painting device of claim 3, wherein said plurality of bristles is bundled together in such a configuration so as to approximate the size and orientation of a scalpel blade.

9. The scalpel brush painting device of claim 4, wherein said plurality of bristles is bundled together in such a configuration so as to approximate the size and orientation of a scalpel blade.
